(19) United States
(12) Patent Application Publication
(10) Pub. No.: US 2025/0365302 A1
(43) Pub. Date: Nov. 27, 2025

(54) System and method for security platform and services for protecting an artificial intelligence system and its components against threats, risks and vulnerabilities

(71) Applicant: Tag Security Networks, Inc., Milpitas, CA (US)

(72) Inventor: Srinivasa Mommileti, Milpitas, CA (US)

(21) Appl. No.: 19/204,489

(22) Filed: May 10, 2025

Related U.S. Application Data
(60) Provisional application No. 63/650,107, filed on May 21, 2024.

(51) Int. Cl. H04L 9/40

(52) U.S. Cl. CPC H04L 63/1425; H04L 63/1416

(57) ABSTRACT

A system for a security platform and services for protecting an artificial intelligence system, comprising: wherein the security platform detects all events and creates a log of anomalous events; wherein a detector detects malware based on the anomalous events; wherein the security platform analyzes the malware by creating a risk analysis based on each detected malware; wherein based on the risk analysis, the security platform engages in adversarial threat mapping; wherein adversarial threat mapping includes input filtering, output filtering and masking; wherein the security platform also tracks the malware utilizing a variety of tracking services; wherein, if malware is detected, then the security platform informs a user of the system that the user has been hacked; wherein if the malware is contained, the security platform attempts to identify where the malware came from; wherein 1 form of finding an origin of the malware is engaging in incident correlation.

### FIELD OF THE INVENTION

The present invention relates to a system and method for security platform and services for protecting an artificial intelligence (“AI”) system and its components against threats, risks and vulnerabilities.

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties Such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an and “the includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range.

Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “Such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any Such inclusion or deletion occurs, the specification is herein deemed to contain the group as modified thus fulfilling the written description of all Markush groups used in the appended claims.

Today, the risks of artificial intelligence are everywhere in software and on the internet. Artificial intelligence can be used by hackers to infiltrate another user's computer or server, without that user ever knowing they have been hacked. It is a common saying that a company has either been hacked, or doesn't know that it has been hacked, suggesting that nearly every company has been hacked.

Once a user realizes they have been hacked, they might take some steps to remove the malware or other form of hacking. However, it is often the case that a user remains unaware of the hack either until it's too late, or the user never finds out.

There are numerous different types of attacks, including: adversarial attacks, poison and evasion attacks, training time attacks, inference time attacks, distortion attacks, traversal attacks, polarization attacks, contamination attacks, polarized data pollution attacks, prompt slicing attacks, feature corruption attacks, external agency attacks and internal agency attacks. Transboundary pollution is the result of contaminated Features, Data, Prompts from one Environment spilling into the classify, training, inference pipelines of another.

AI can be used to infiltrate another user's computer/server, for example: AI can be deployed as an Application or through Cloud Services. Also, users can access AI applications and Services, just like they would do with Web Applications. 2 different forms of interface are direct interface and indirect interface. Direct interface will be by input text, images and media, so there are multiple modal inputs. An AI application that can infiltrate through direct interface can also include a Chat bot, Customer agent, Research Analysis, Pricing application, Insurance Quotes, Document/Content writing, Decision making systems, and other similar systems.

Adversaries can access AI apps and services through an interface, and inject adversarial inputs. AI services use AI models that are trained on training data. The training data can also be infiltrated, which would give adversarial outputs. Some adversaries can be injected into systems using reinforcement learning human feedback loops that are used in AI systems.

### SUMMARY

The present invention solves these issues, because the present invention is a set of security services for protecting artificial intelligence enabled systems. The present invention includes a multi layer, multi resources and multi process discovery, tracking via tracking services, lineage, risk analysis, detections, anomalous logs, event detections, metrics variance, time-series forecasting observations to adversarial threat mapping, with input, output filtering, masking, forwarding to incident correlation. These systems and methods alert a user that they have been hacked, analyze the threat, trace its origins and help to prevent the threat from recurring.

These systems and methods are necessary in terms of alerting a user that they have been hacked, and in identifying who is the hacker, and all aspects of the hack. This way the user does not remove 1 aspect of the hacker's malware, and fail to remove another, because the present invention will trace and analyze all aspects of such malware.

Furthermore, there will be no time lost, because the user will be alerted immediately to the hacker's presence. So often it takes years for companies to become aware that they were hacked. The present invention should help a user become aware in seconds. In addition, the present invention can forecast and so predict the location and activity of the malware.

Architecture & components of the present invention include: injectors (scrappers/pollers/exporters), discoverers, resource-trackers, detectors (anomalous log message Detector, anomalous metric detector, model-behavior-detector, data pipeline lineage analyzer and detector, AI resource tracking via tracking services and analyzer, artifacts change detector and AI risk forecasting detector, copyright and legal exposures detector, sensitive information disclosures detector, data privacy violation detector, social engineering attacks detector and tagging and labelling, correlation, enrichment for AI alerts and forwarding to security information and event management (“SIEM”) systems.

The different aspects of the invention include:
Discovery: Discovery, Lineage & Analysis
AI visibility: Inventory, Monitoring & Tracking via tracking services Models
Detections: Anomalies, Threat Forecasting
Adversarial analytics: Adversarial Attacks
Large Language model (“LLM”), a computational model notable for its ability to achieve general-purpose language generation and other natural language processing tasks such as classification, Prompt analytics: Prompt interaction analytics
Prompt risk analytics, Prompt Injections detector
Prompt web application Filter
SIEM event generation, Enrichment, Forwarding

The security platform & services, including the above architecture, components and aspects, function in the way shown on a flow chart. The steps are:
1. providers, platforms, libraries, tools, services, compute, network infrastructure
2. forwarders
3. injectors, (Polling/API clients/Push)|Metrics, Events, Logs, Traces
4. receptors
5. data lake+data ware house of security features
6. featurization, sessionization, security analytics, models
7. AI process classification, forecasting, anomaly detections
8. Visibility, Integrity, Adversarial Threat detection, Privacy/sensitive information detection,
AI forensics/Incident/Footprint analytics, AI provenance and lineage,
Security, Ethics, Performance detections,
Model life cycle analytics, LLM Model vulnerabilities, AI Red teaming (Model Testing) orchestrations.
9. Inline and Offline Gateway Http process
10a. Integrations Configuration (item 1 access is configured to Alert AI system)
10b. Web UI Configurations

This flow chart is shown in FIG. 1. Step 101 includes creating providers, platforms, libraries, tools, services, compute and network infrastructure. Step 102 includes creating forwarders. Step 103 includes injectors, (Polling/API clients/Push)|Metrics, Events, Logs and Traces. Step 104 includes creating receptors. Step 105 includes creating data lake+data ware house of security features. Step 106 includes creating featurization, sessionization, security analytics and models. Step 107 includes AI process classification, forecasting, anomaly detections. Step 108 includes creating Visibility, Integrity, Adversarial Threat detection, Privacy/sensitive information detection, AI forensics/Incident/Footprint analytics, AI provenance and lineage, Security, Ethics, Performance detections, Model life cycle analytics, LLM Model vulnerabilities and AI Red teaming (Model Testing) orchestrations. Step 109 includes creating Inline and Offline Gateway Http process. Step 110 includes creating Integrations Configuration (item 1 access is configured to Alert AI system). Step 111 includes creating Web UI Configurations.

Each step in this flow chart also brings back data to integrate into other steps of the flow chart. The data can be across streaming datasets. The Pub/sub is by services. Services have input data type and output data type. Services interconnect through data type and shared queue of events data.

In one embodiment of the present invention, there are several environments of AI systems running, like development, staging, testing and production. Training data and configuration can be inadvertently moved to other environments. Examples of configuration of testing may have more exposure to infiltration and less control over defending against infiltration. AI services use models that are based on features, wherein these features may be susceptible to intra-environmental pollution, including transboundary pollution.

In another embodiment of the present invention, a security platform collects data in order to create a time series and forecasting system. There are messaging and streaming datasets that will be used to store the collected time series data. The security platform for streaming data can be used to collect, process, store, and integrate data.

The security platform has metrics. These metrics offer several statistics like counters, gauges, histograms and summaries. Each metric type serves specific monitoring needs and use cases. A different type of these metric data is interpreted for effective security analytics.

The present invention is different from existing malware detection because AI and LLM vulnerabilities are based on a model's inference like response and a model's inputs like prompts, training dataset, algorithms and fine-tuning configurations. These vulnerabilities are of data leakage, privacy of sensitive information in content, and similar issues. Also, AI services automate processes, and these vulnerabilities can detect misguided AI services to alter and take adversarial actions against infiltration.

The present invention's security platform & services includes AI systems that are distributed systems. One layer of the distributed systems include inference services lead to external and internal user access. The next layer of the distributed systems above include models, datasets, data pipelines, features and training data. The last layer of the distributed systems above includes cluster and compute resources, and network resources.

An interface for the security platform & services to talk to a user's infrastructure is that an end user will use AI services through multi modal inputs like Text, image and media. AI services will perform background decisions and generate responses.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a flow chart of one embodiment of the security platform and services.

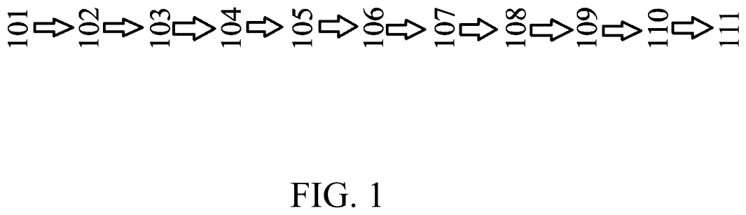

FIG. 2 is a drawing of different steps of the AI detection and analysis process according to various embodiments of the present disclosure.

FIG. 3 is a drawing of different steps for risk analysis, filtering and SIEM according to various embodiments of the present disclosure.

FIG. 4 is a drawing of different aspects of the invention, including discovery, tracking via tracking services, and detecting and preventing, according to various embodiments of the present disclosure.

FIG. 5 is a drawing of a breakdown of the categories of AI security activity according to various embodiments of the present disclosure.

FIG. 6 is a drawing of pipelines, models, LLMs, prompts, infrastructure, compute and networks according to various embodiments of the present disclosure.

FIG. 7 is a drawing of Al Detection & Response (“ADR”) according to various embodiments of the present disclosure.

FIG. 8 is a drawing of a flow chart that starts with a security platform that detects all events and creates a log of anomalous events.

### DETAILED DESCRIPTION

Various embodiments of the present disclosure relate to providing a system and method for security platform and services for protecting an artificial intelligence system and its components against threats, risks and vulnerabilities.

The following components operate independently of each other. These components function all the time, and are not required to start or stop in any sequence. The components of the system interact at a high level as follows:
1) Users of the system interact with a Web User interface, which belongs to an Underlying system being protected.
2) the Web User interface sends information on a user to an application programming interface (“API”) server service, wherein an API server is a tool that allows a user to build, manage and deploy APIs.
4) an API server service sends data to a Nosql DB (MongoDB) collections. This allows the data to be kept in the collection.
5) a Message Queue collection Readers Write To a NoSql Collections. This allows all messages to be saved.
6) there is a Discovery process for identifying Artificial intelligence or machine learning resources and infrastructure from data from Providers. The Discovery process uses Providers to collect data via API clients, metrics and event logs that are provided by libraries and services of the Providers.
7) there is an AI visibility process for identified Artificial intelligence or machine learning resources, and data on those resources are sent as applications from configured Tracking via tracking services servers. The main process of the AI visibility process is to identify resources and security requirements for each discovered attack, thus enabling an elimination of security blind spots. A tracking via tracking services server provides a solution for collecting and sending real-time data from many sources and formats to Web and desktop clients. As real-time data is received by Tracking via tracking services Server, it can be logged to a file or distributed to Web and desktop clients.
8) there is a Data Lineage analysis process for identifying and recording data source, sink Extract, Transformation, Load pipelines and map, topology of data origin and transformations. The Data lineage analysis process includes understanding, recording, and visualizing data as it flows from data sources to consumption. This includes all transformations the data underwent along the way-how the data was transformed, what changed, and why. Data lineage allows companies to track errors in data processes.
9) there is an artificial intelligence Pipeline analysis process for identifying training, inference pipelines and workloads, computation statistics, Tasks, Stages, Query states, Compute and Digital FootPrint Marking. A digital footprint is a trail of data formed by somebody's online activity. Surfing the web is like walking in sand: Wherever you step, you leave behind a visible mark of your presence. When you browse a site, when you log into an account, or click on a link, your actions are recorded in some way.
10) there is a Detection pipeline service for Anomalous log events from Artificial intelligence applications and Artificial intelligence services in the system
11) there is a Time series forecasting pipeline for statistics and metrics collected from Artificial intelligence applications and Artificial intelligence services, and infrastructure, network and computational analysis.
12) there are Threat Mapper services
13) there are Risk Analyzer services
14) there are Artificial intelligence Web Application Filter services for Input Output Filtering and Output field Masking of Classified and sensitive data.
15) there is a Log forwarding service for Artificial intelligence threat Event enrichment and correlation, wherein enrichment and correlation data is sent to a third party service. The third party service listens and receives security events via http or syslog protocols.
16) there are API clients to Collect data from Artificial intelligence libraries and Providers.
17) there is a Metric Scrap and Send to message queue, rate limit, and sampling Adaptors. A metric scrap is a collection service that collects metrics from artificial intelligence (“AI”) or machine learning (“ML”) applications and services, and publishes that data to a topic in a message queue. The rate limit and sampling adaptors select subsets of metrics by configured amount over a period and drop the rest of the metrics. The sampling adaptor takes metrics as input and converts those metrics into a message on topic.
18) the Data science and AI applications send data to an Underlying system being protected
19) the Cloud or Datacenter or Workstation send data to the Underlying system being protected

In one embodiment of the present invention, the Core process is as follows: the AI systems are dissected as a Distributed system with multiple functional “Subsytems”, wherein each Subsystem is configured as “Providers”. One example of a Provider Configuration is: Different providers have different authentication authorization requirements. One example of an authentication authorization is a token based authentication, including a service account and similar accounts. One part of the process involves identifying a user supplied configuration, meaning users of the distributed system, and providers' input configuration. A provider uniquely identifies a subsystem. In another embodiment of the present invention, an AI/ML system may comprise cloud cluster Resources, like a cloud provider container orchestrations that are a system for software development, scaling and management that assembles one or more computers, either virtual machines or physical computers, into a cluster which can run workloads in containers. Then cloud cluster resources configure a provider of these cloud cluster resources as a service. This results in authentication of the provider to connect via API client, token, service account, user name, password, etc.

In another embodiment of the present invention, An AI/ML system includes Multiple Subsytems, wherein each Subsystem includes Cluster resources+ML OPS platforms+Data Analytics Libraries+ML Tracking via tracking services+AI/ML third party services plus other factors as well. Each of these “subsystems” is mapped to a “Provider” and “Provider Configuration”. Using “Provider Configuration” enables Connect to the Subsystem and Collect Metrics, Events and Logs used in Discovery and Other Processes. There is a set of Data collection processes that connect with Providers. Metrics scrappers and API clients are configured to connect with Providers and message brokers to write output data into a Topic as a Time series Data. A set of Discovery processes read the Time series data from Topic, then classifies into a resource. Each resource is tagged with Labels with Observed data. Labels is a set of key, value pairs of name and value, and optional additional context. Resources are also associated with structured data with fields ID, Provider, Tenant, Source, Type, Name and Value. The AI/ML system also uses an event streaming platform message broker, and creates multiple topics for input and output for each processes to subscribe and consume.

In another embodiment of the present invention, the discovery process is as follows: The discovery process reads configuration parameters of input source, input schema, type of input and output source. Then the discovery process loads input data into an in-memory table as rows and columns. For each row of data, the discovery process classifies that row of data into a resource of the subsystem. Then the discovery process adds Labels, a set of keys and value pairs of name and value. Then the discovery process adds optional additional context, and structured data with fields ID, Provider, Tenant, Source, Type, Name and Value. Then the discovery process writes the resources data into an output source as a string of key, value pairs as JavaScript Object Notation (“JSON”), an open standard file format and data interchange format that uses human-readable text to store and transmit data objects consisting of attribute value pairs and arrays or other serializable values, that is language independent, string data.

In one embodiment of the present invention, the value pairs JSON string data includes:
[System]
[Subsystems]
[Provider component]
[Authentication with Provider]
[API client]
[Metric scrapper]
[Write to Topic]
[Topic, Message Broker]
[Discovery Process]
   <Read, Classify, Attach Tags, Labels, Write>
[Topic, Message Broker]

In another embodiment of the present invention, the Discovery Subsystems include: Cloud provider container orchestrations that are a system for software development, scaling and management that assembles one or more computers, either virtual machines or physical computers, into a cluster which can run workloads in containers, Observability libraries of cloud network and infrastructure, Data analytics libraries including a unified analytics engine for large scale data processing, that is an interface for programming clusters with implicit data parallelism and fault tolerance; a unified programming model to define and execute data processing pipelines, including exact transform, load, batch and stream (continuous) processing; a fully managed streaming analytics service that minimizes latency, processing time and cost through autoscaling and batch processing; on-demand cloud computing, platforms and APIs provided on a metered pay-as-you-go basis, often used in combination with autoscaling (a process that allows a client to use more computing in times of high application usage, and then scale down to reduce costs when there is less traffic); a cloud big data platform for running large-scale distributed data processing jobs, interactive SQL queries and machine learning applications; Machine Learning ops tracking via tracking services libraries and services that manage end-to-end ML and generative AI (“GenAI”) workflows, from development to production, or provide a cloud-based platform to help enterprises build, scale, and govern data and AI, including generative AI and other machine learning data models, or a paradigm that deploys and maintains machine learning models in production reliability and efficiency, wherein Machine learning models are tested and developed in isolated experimental systems, AI/ML training and inference libraries and services, Observability libraries of AI/ML ops, Threat Intelligence Real Simple Syndication (“RSS”) feeds and Vulnerabilities Databases.

In another embodiment of the present invention, a Cloud infrastructure Discovery component reads Metrics, Logs data provided by a Cloud provider container orchestration that is a system for software development, scaling and management that assembles one or more computers, either virtual machines or physical computers, into a cluster which can run workloads in containers Control and data plane components, performs a Data Pipeline Discovery process, and reads Event Logs, Metrics generated by Data Analytics Libraries used in AI systems including a unified analytics engine for large scale data processing, that is an interface for programming clusters with implicit data parallelism and fault tolerance, a unified programming model to define and execute data processing pipelines, including exact transform, load, batch and stream (continuous) processing and a distributed system for efficient data extraction, aggregation and movement from various sources to a centralized storage or processing system in big data environments.

In another embodiment of the present invention, a ML resource AI visibilityProcess component includes a tracking via tracking services process that is configured with tracking via tracking services in the AI system. One example is Machine Learning ops tracking via tracking services libraries and services that manage end-to-end ML and GenAI workflows, from development to production tracking via tracking services server or 3rd party ML Tracking via tracking services server. In these examples, the ML resources AI visibilityProcess component reads configuration parameters to connect like authentication, service address and port connects using an API client. The ML resource AI visibility Process component reads data using API. There are scraps Metrics available. The ML resource AI visibility Process component loads input data into an in-memory table as rows and columns. For each row of data, the ML resource AI visibility Process component classifies that row of data into a resource of the subsystem, adds Labels, a set of keys, value pairs of name and value and optional additional context. The ML resource AI visibility Process component also includes structured data with fields ID, Provider, Tenant, Source, Type, Name and Value. The ML resource AI visibility Process component then writes the resources data into output source as string of key and value pairs as JSON string data. Then the ML resource AI visibility Process component generates reports for Resource Usage and correlation of associated resources like Jobs, Runs, Tasks and compute.

In another embodiment of the present invention, a Change Detectors process component continuously reads Time-series input data and compares with Lead/Lag pointers and offsets, and identifies change records with configured field data and time intervals.

In another embodiment of the present invention, a Lineage Analyzer process component reads Data analytics logs generated by distributed data analytics like map/reduce components in system. The component then Loads a custom Plugin that reads event logs generated by analytics libraries. The component then parses event data from Query listeners. The component then adds structured data with the following fields: ID, Provider, Tenant, Source, Type, Name, and Value. The component then writes data into Output source as string of key, value pairs JSON string data.

In another embodiment of the present invention, lineage can be traced through record of modifications, record of change data, input dataset and output dataset. There are time stamps for each generation. There are also compute details per job run.

In another embodiment of the present invention, a Data Pipeline Analyzer process component reads Data analytics logs generated by distributed data analytics like map/reduce components in a system. The Data Pipeline Analyzer parses execution data, task and job data and Success and Failures data. The Data Pipeline Analyzer also adds structured data with fields ID, Provider, Tenant, Source, Type, Name and Value. The Data Pipeline Analyzer writes the data into an Output source as a string of key, value pairs as JSON string data.

In another embodiment of the present invention, there is an Anomalous log Detection process component. The component configures each log into a unique Log type with Provider, Source and Type. A machine learning model is created by training each log independently by the log's historic data. An inference pipeline loads a Model, new logs are injected to Topic in Message broker and read by an Inference pipeline. Anomalies are determined by the Model. The component adds structured data with fields ID, Provider, Tenant, Source, Type, Name and Value. The component writes the Anomalies data into Output source as string of key, value pairs as JSON string data.

In another embodiment of the present invention, there is an Anomalous statistics Detection process component. The component configures Metrics into a unique Metric type with Provider, Source, Type. A machine learning model is created by training each Metric is independently by its historic data. An inference pipeline loads the Model. New logs are injected to a Topic in a Message broker, and are read by an inference pipeline. Anomalies are determined by the Model. The component adds structured data with fields ID, Provider, Tenant, Source, Type, Name and Value. The component writes a forecasted value and current value into an output source as a string of key, value pairs as JSON string data.

In another embodiment of the present invention, there is an AI Risk detection process component. The component reads an input threat configuration data set, subscribes Detection events, and generates an input topic by an anomalous statistics detection process and anomalous log detection process and discovery processes. The component then aggregates the Detection events into 1 session. The component then identifies any threats, and adds Correlation data to threats with fields ID, Provider, Tenant, Source, Type, Name and Value. The component then performs Risk analysis that produces AI Risk name, type and Score. The component then writes the forecasted value and current value into Output source as string of key, value pairs JSON string data.

In another embodiment of the present invention, there is a Model and LLM vulnerabilities scan process component. The component reads vulnerabilities and scans results via a tracking via tracking services. The component then utilizes software applications to write evaluation metrics into a tracking via tracking services. The component then tracks, audits and classifies as Risks, and then Tags and Correlates with Environment, Model, Pipeline, Data sets versions. The component then adds structured data with fields ID, Provider, Tenant, Source, Type, Name and Value. The component then writes a forecasted value and a current value into an output source as a string of key, value pairs as JSON string data.

In another embodiment of the present invention, there is an AI Web Application Filter Process Filtering component, which is a novel method to determine malicious input prompts, sensitive information, data privacy detections, social engineering attacks into LLM Models, and filters such input and output. The component reads model inference web application input data and determines risk configuration. The component then instantiates a sensitive information detector, and then loads a Natural Language Processing NLP model with a real-time request/response servlet filter, inference controller, inference service, prediction repository, auth provider, admission controller policy, request logger, visitor counter, filter chain, Custom, logging, encoding filters. Based on a prediction from the NLP model, sensitive information detection is scored based on risk. The component then adds structured data with fields ID, Provider, Tenant, Source, Type, Name and Value. The component then writes permissible inputs topics or rejected inputs topics.

In another embodiment of the present invention, there is an AI web application filter process masking component that subscribes to sensitive information detector output messages, creates output event with masked offsets and field labels, writes output event and mask report events, adding fields ID, Provider, Tenant, Source, Type, Name and Value. An AI web application filter will filter based on privacy, sensitive information and data leakage prevention.

In another embodiment of the present invention, there is an AI security information and event management (“SIEM”) security incident and event management Process Component that reads all topics from discovery, tracking via tracking services, lineage, detections, risks and rejected inputs. The component then writes into SIEM event report, adds structured data with fields ID, Provider, Tenant, Source, Type, Name and Value. The component then forwards to syslog, http, smtp servers configured.

In another embodiment of the present invention, there is a legal exposures detector.

In another embodiment of the present invention, there is an adversarial attacks detector. The detector connects and reads all threat intelligence and configuration from a database. The Connector connects and reads topic data and meta data from detections. The Connector creates a session table, and then breaks into sessions and aggregates Minutes, Hourly and Daily Observations. The Connector correlates detections to discovery, tracking via tracking services, lineage, risks and rejected inputs. The Connector then converts to Features, and converts Features to a Threat Model, Predictions and Thresholds to Threat Identification. Then the Connector writes into a SIEM event report, adds structured data with fields ID, Provider, Tenant, Source, Type, Name and Value. Finally, the Connector forwards to syslog, http and smtp servers configured.

The detector has different configurations and thresholds. There are anomaly detections, forecast comparison estimates and other configurations. There are high, medium and low thresholds in terms of the level of adversarial attacks that will be detected by the detector. There are different models the detector uses, including a regression model. The detector receives data for a regression model in different ways, including time series log, metrics, traces and event data. Different embodiments may include one or any combination of these different ways of receiving data. The anomaly detection can utilize application intelligence, security signals, fine tuning, customization, data collection and analytics, and featurization.

The security platform & services will use AI to forecast by utilizing time series forecasting algorithms and models. The model will be trained and uniquely identifiable by a labelled series of data. A security constraint that a user must be ready to give data back to the security platform & services. Fine granular access will depend on service and services features. For example: read only, audit logs, transaction logs and Application programming interface (“API”) call history.

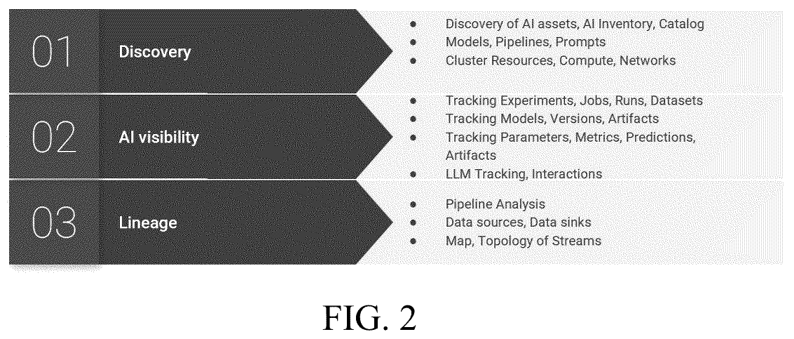

One embodiment of the present invention is displayed in FIG. 2, in which stage 1 involves discovery of AI assets, AI inventory and catalog. After that, the security platform creates models, pipelines and prompts. After that, the security platform handles cluster resources and compute networks. Stage 2 involves the security platform performing tracking experiments, running jobs, performing runs, and analyzing datasets. Then the security platform creates tracking models, different versions and artifacts. After that, the security platform creates tracking parameters, creates and analyzes metrics, and makes predictions and artifacts. After that, the security platform performs LLM tracking and determines interactions of any malware. Stage 3 involves the security platform performing pipeline analysis, and analyzing data sources and data sinks. The security platform then creates a map based on topology of streams related to potential malware. Various actions can be done at different points, and so this is not the only series of events that the security platform can perform.

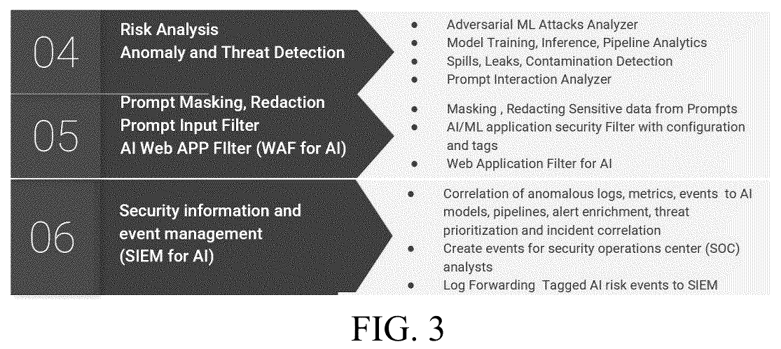

FIG. 3 continues actions of the security platform. Step 4 involves risk analysis and anomaly and threat detection. The security platform performs an adversarial ML attacks analyzer. The security platform then begins model training, inference and pipeline analytics. The security platform then detects spills, leaks and other contamination detection. The security platform then runs a prompt interaction analyzer. Step 5 involves prompt masking, redaction, prompt input filter and an AI web app filter. The security platform performs masking and redacting sensitive data from prompts. The security platform then runs an AI/ML application security filter with configuration and tags. The security platform then runs a web application filter for AI. Step 6 involves SIEM for AI. The security platform performs a correlation of anomalous logs, metrics, events to AI models, pipelines, alert enrichment and threat prioritization and incident correlation. Then the security platform creates events for a security operations center (“SOC”) analysts. Lastly, the security platform performs log forwarding and tags AI risk events to SIEM. Various actions can be done at different points, and so this is not the only series of events that the security platform can perform. In fact, actions from steps 1-3 can be intermixed with steps 4-6.

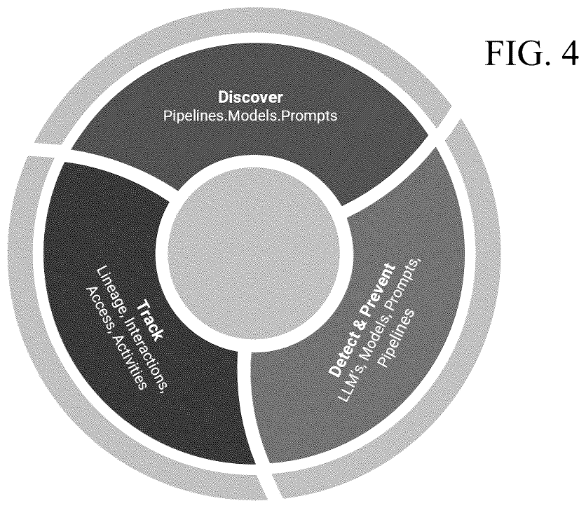

FIG. 4 displays another embodiment of the present invention. In one part of the invention, the security platform discovers pipelines, models and prompts. In another part of the invention, the security platform detects and prevents LLMs, models, prompts and pipelines. In another part of the invention, the security platform tracks lineage, interactions, access and activities.

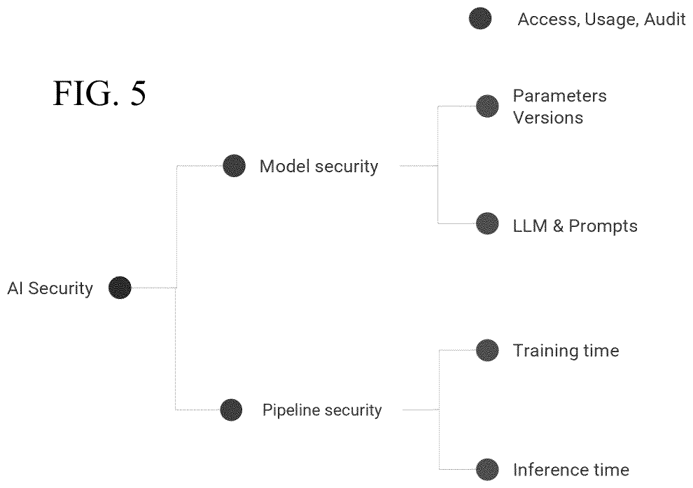

FIG. 5 displays another embodiment of the present invention in the sense of breaking down the different parts of the security platform into component parts. The “AI Security” is the security platform, which is broken into 2 parts: model security and pipeline security. Model security is broken down into parameters versions and LLM & prompts. Pipeline security is broken down into training time and inference time. A separate aspect of the invention is Access, usage and audit. Another separate aspect of the invention is compute, network.

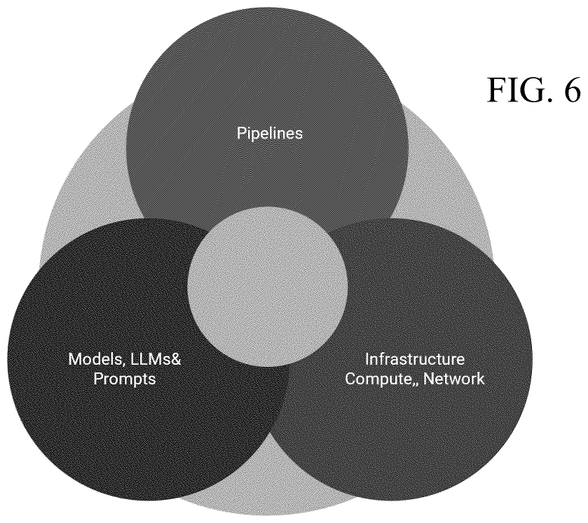

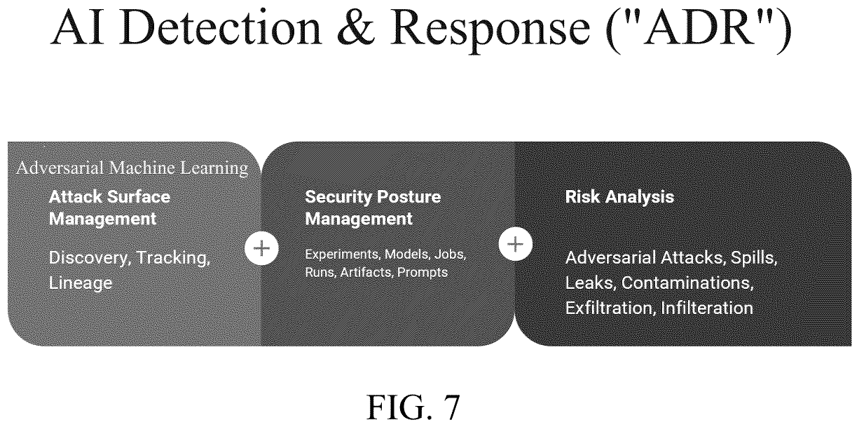

FIG. 6 display another embodiment of the present invention. One aspect is pipelines, another aspect is infrastructure, computer and network, and another aspect is models, LLMs and prompts. FIG. 7 display another embodiment of the present invention. Here, the present invention includes adversarial machine learning, attack surface management, including discovery, tracking and lineage. Another aspect of the invention is security posture management, including experiments, models, jobs, runs, artifacts and prompts. Another aspect of the invention is risk analysis, including adversarial attacks, spills, leaks, contaminations, exfiltration and infiltration. These actions can be taken in any order.

Another embodiment of the present invention is a method for a security platform and services for protecting an artificial intelligence system, comprising: wherein the security platform detects all events and creates a log of anomalous events; wherein a detector detects malware based on the anomalous events; wherein the security platform analyzes the malware by creating a risk analysis based on each detected malware; wherein based on the risk analysis, the security platform engages in adversarial threat mapping; wherein adversarial threat mapping includes input filtering, output filtering and masking; wherein the security platform also tracks the malware utilizing a variety of tracking services; wherein, if malware is detected, then the security platform informs a user of the system that the user has been hacked; wherein if and when the malware is contained, the security platform attempts to identify where the malware came from; wherein 1 form of finding an origin of the malware is engaging in incident correlation, wherein an incident is compared to past incidents to see if there is a similarity; wherein another form of finding an origin of the malware is analyzing lineage of the malware; wherein the detector detects different types of anomalous events, including: anomalous log messages; data pipeline lineage; AI resource tracking; Artifacts change; AI risk forecasting; Copyright & legal exposure; Sensitive information disclosure; Data privacy violation; Social engineering attack; Tagging attack; and Labelling attack; wherein the artificial intelligence system accepts prompts from a user; wherein the security platform performs prompt analytics on the prompts entered by the user; wherein the prompt analytics include prompt interaction analysis, prompt risk analysis, prompt injections detector and a prompt web application filter; wherein anomalous events are detected utilizing 1 or more of the following: application intelligence, security signals, fine tuning, customization, data collection and analytics, and featurization; wherein the Detector connects and reads all threat intelligence and configuration from a database; wherein a Connector connects and reads topic data and meta data from detections; wherein the Connector creates a session table; wherein the Connector breaks parts of the session table into sessions and aggregates observations based on time, including minutes, hours and days; wherein the Connector correlates detections to discovery, tracking via tracking services, lineage, risks and rejected inputs; wherein the Connector then converts threat information to features, and converts features to a Threat Model; and wherein the Threat Model is analyzed in light of predictions and thresholds to identify actual threats.

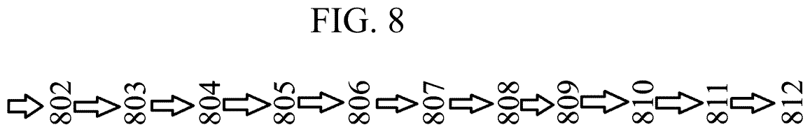

FIG. 8 displays this embodiment, wherein step 801 is when the security platform detects all events and creates a log of anomalous events. Step 802 is when the detector detects malware based on the anomalous events. Step 803 is when the security platform analyzes the malware by creating a risk analysis based on each detected malware. Step 804 is when, based on the risk analysis, the security platform engages in adversarial threat mapping. Adversarial threat mapping includes input filtering, output filtering and masking. Step 805 is when the security platform also tracks the malware utilizing a variety of tracking services; wherein, if malware is detected, then the security platform informs a user of the system that the user has been hacked; wherein if and when the malware is contained, the security platform attempts to identify where the malware came from. Step 806 is when 1 form of finding an origin of the malware is engaging in incident correlation, wherein an incident is compared to past incidents to see if there is a similarity; wherein another form of finding an origin of the malware is analyzing lineage of the malware. Step 807 is when the detector detects different types of anomalous events, including: anomalous log messages; data pipeline lineage; AI resource tracking; Artifacts change; AI risk forecasting; Copyright & legal exposure; Sensitive information disclosure; Data privacy violation; Social engineering attack; Tagging attack; and Labelling attack. Step 808 is when the artificial intelligence system accepts prompts from a user; wherein the security platform performs prompt analytics on the prompts entered by the user; wherein the prompt analytics include prompt interaction analysis, prompt risk analysis, prompt injections detector and a prompt web application filter. Step 809 is when anomalous events are detected utilizing 1 or more of the following: application intelligence, security signals, fine tuning, customization, data collection and analytics, and featurization. Step 810 is when the Detector connects and reads all threat intelligence and configuration from a database. Step 811 is when a Connector connects and reads topic data and meta data from detections; wherein the Connector creates a session table; wherein the Connector breaks parts of the session table into sessions and aggregates observations based on time, including minutes, hours and days; wherein the Connector correlates detections to discovery, tracking via tracking services, lineage, risks and rejected inputs; wherein the Connector then converts threat information to features, and converts features to a Threat Model. Step 812 is when the Threat Model is analyzed in light of predictions and thresholds to identify actual threats.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A system for a security platform and services for protecting an artificial intelligence system, comprising:
wherein the security platform detects all events and creates a log of anomalous events;
wherein a detector detects malware based on the anomalous events;
wherein the security platform analyzes the malware by creating a risk analysis based on each detected malware;
wherein based on the risk analysis, the security platform engages in adversarial threat mapping;
wherein adversarial threat mapping includes input filtering, output filtering and masking;
wherein the security platform also tracks the malware utilizing a variety of tracking services; and
wherein, if malware is detected, then the security platform informs a user of the system that the user has been hacked.

2. The system of claim 1, further comprising:
wherein if and when the malware is contained, the security platform attempts to identify where the malware came from;
wherein 1 form of finding an origin of the malware is engaging in incident correlation, wherein an incident is compared to past incidents to see if there is a similarity; and
wherein another form of finding an origin of the malware is analyzing lineage of the malware.

3. The system of claim 2, further comprising:
Wherein analyzing lineage of the malware includes:
identifying a data source;
recording a data source;
sinking extract;
identifying any transformation of the malware;
identifying any loading of pipelines;
creating a map or topology of an origin of the malware;

4. The system of claim 3, further comprising:
wherein the security platform visualizes data that accompanied the malware;
whereas the security platform identifies errors made in allowing in data that accompanied the malware; and
wherein the security platform corrects those errors such that future malware will not enter the Artificial Intelligence system in the same way.

5. The system of claim 1, further comprising:
Wherein the detector detects different types of anomalous events, including:
anomalous log messages;
data pipeline lineage;
AI resource tracking;
Artifacts change;
AI risk forecasting;
Copyright & legal exposure;
Sensitive information disclosure;
Data privacy violation;
Social engineering attack;
Tagging attack; and
Labelling attack.

6. The system of claim 1, further comprising:
wherein the security platform forwards information about the malware to a security information and event management (“SIEM”) system.

7. The system of claim 1, further comprising:
wherein the artificial intelligence system accepts prompts from a user;
wherein the security platform performs prompt analytics on the prompts entered by the user;
wherein the prompt analytics include prompt interaction analysis, prompt risk analysis, prompt injections detector and a prompt web application filter.

8. The system of claim 1, further comprising:
wherein anomalous events are detected utilizing 1 or more of the following:
application intelligence, security signals, fine tuning, customization, data collection and analytics, and featurization.

9. The system of claim 1, further comprising:
wherein the Detector connects and reads all threat intelligence and configuration from a database;
wherein a Connector connects and reads topic data and meta data from detections;
wherein the Connector creates a session table;
wherein the Connector breaks parts of the session table into sessions and aggregates observations based on time, including minutes, hours and days;
wherein the Connector correlates detections to discovery, tracking via tracking services, lineage, risks and rejected inputs;
wherein the Connector then converts threat information to features, and converts features to a Threat Model; and
wherein the Threat Model is analyzed in light of predictions and thresholds to identify actual threats.

10. A method for a security platform and services for protecting an artificial intelligence system, comprising:
wherein the security platform detects all events and creates a log of anomalous events;
wherein a detector detects malware based on the anomalous events;
wherein the security platform analyzes the malware by creating a risk analysis based on each detected malware;
wherein based on the risk analysis, the security platform engages in adversarial threat mapping;
wherein adversarial threat mapping includes input filtering, output filtering and masking;
wherein the security platform also tracks the malware utilizing a variety of tracking services;
wherein, if malware is detected, then the security platform informs a user of the system that the user has been hacked;
wherein if and when the malware is contained, the security platform attempts to identify where the malware came from;
wherein 1 form of finding an origin of the malware is engaging in incident correlation, wherein an incident is compared to past incidents to see if there is a similarity;
wherein another form of finding an origin of the malware is analyzing lineage of the malware;
wherein the detector detects different types of anomalous events, including:
anomalous log messages;
data pipeline lineage;
AI resource tracking;
Artifacts change;
AI risk forecasting;
Copyright & legal exposure;
Sensitive information disclosure;
Data privacy violation;
Social engineering attack;
Tagging attack; and
Labelling attack;
wherein the artificial intelligence system accepts prompts from a user;
wherein the security platform performs prompt analytics on the prompts entered by the user;
wherein the prompt analytics include prompt interaction analysis, prompt risk analysis, prompt injections detector and a prompt web application filter;
wherein anomalous events are detected utilizing 1 or more of the following:
application intelligence, security signals, fine tuning, customization, data collection and analytics, and featurization;
wherein the Detector connects and reads all threat intelligence and configuration from a database;
wherein a Connector connects and reads topic data and meta data from detections;
wherein the Connector creates a session table;
wherein the Connector breaks parts of the session table into sessions and aggregates observations based on time, including minutes, hours and days;
wherein the Connector correlates detections to discovery, tracking via tracking services, lineage, risks and rejected inputs;
wherein the Connector then converts threat information to features, and converts features to a Threat Model; and
wherein the Threat Model is analyzed in light of predictions and thresholds to identify actual threats.

11. A method for a security platform and services for protecting an artificial intelligence system, comprising:
wherein the security platform detects all events and creates a log of anomalous events;
wherein a detector detects malware based on the anomalous events;
wherein the security platform analyzes the malware by creating a risk analysis based on each detected malware;
wherein based on the risk analysis, the security platform engages in adversarial threat mapping;
wherein adversarial threat mapping includes input filtering, output filtering and masking;
wherein the security platform also tracks the malware utilizing a variety of tracking services; and
wherein, if malware is detected, then the security platform informs a user of the system that the user has been hacked.

12. The method of claim 11, further comprising:
wherein the detector utilizes different models, including a regression model;
wherein the detector receives data for the regression model in different ways, including: time series log, metrics, traces and event data.

13. The method of claim 11, further comprising:
wherein the security platform utilizes artificial intelligence to forecast incoming malware;
wherein 1 way the security platform makes these forecasts is to utilize time series forecasting.

14. The method of claim 11, further comprising:
wherein if and when the malware is contained, the security platform attempts to identify where the malware came from;
wherein 1 form of finding an origin of the malware is engaging in incident correlation, wherein an incident is compared to past incidents to see if there is a similarity; and
wherein another form of finding an origin of the malware is analyzing lineage of the malware.

15. The method of claim 11, further comprising:
wherein the detector detects different types of anomalous events, including:
anomalous log messages;
data pipeline lineage;
AI resource tracking;
Artifacts change;
AI risk forecasting;
Copyright & legal exposure;
Sensitive information disclosure;
Data privacy violation;
Social engineering attack;
Tagging attack; and
Labelling attack.

16. The method of claim 11, further comprising:
wherein the security platform forwards information about the malware to a security information and event management (“SIEM”) system.

17. The method of claim 11, further comprising:
wherein the artificial intelligence system accepts prompts from a user;
wherein the security platform performs prompt analytics on the prompts entered by the user;
wherein the prompt analytics include prompt interaction analysis, prompt risk analysis, prompt injections detector and a prompt web application filter.

18. The method of claim 11, further comprising:
wherein anomalous events are detected utilizing 1 or more of the following:
application intelligence, security signals, fine tuning, customization, data collection and analytics, and featurization.

19. The method of claim 11, further comprising:
wherein the Detector connects and reads all threat intelligence and configuration from a database;
wherein a Connector connects and reads topic data and meta data from detections;
wherein the Connector creates a session table;
wherein the Connector breaks parts of the session table into sessions and aggregates observations based on time, including minutes, hours and days;
wherein the Connector correlates detections to discovery, tracking via tracking services, lineage, risks and rejected inputs;
wherein the Connector then converts threat information to features, and converts features to a Threat Model; and
wherein the Threat Model is analyzed in light of predictions and thresholds to identify actual threats.

20. The method of claim 11, further comprising:
wherein the detector utilizes different models, including a regression model;
wherein the detector receives data for the regression model in different ways, including: time series log, metrics, traces and event data;
wherein the security platform utilizes artificial intelligence to forecast incoming malware;
wherein 1 way the security platform makes these forecasts is to utilize time series forecasting;
wherein if and when the malware is contained, the security platform attempts to identify where the malware came from;
wherein 1 form of finding an origin of the malware is engaging in incident correlation, wherein an incident is compared to past incidents to see if there is a similarity;
wherein another form of finding an origin of the malware is analyzing lineage of the malware;
wherein the detector detects different types of anomalous events, including:
anomalous log messages;
data pipeline lineage;
AI resource tracking;
Artifacts change;
AI risk forecasting;
Copyright & legal exposure;
Sensitive information disclosure;
Data privacy violation;
Social engineering attack;
Tagging attack; and
Labelling attack;
wherein the artificial intelligence system accepts prompts from a user;
wherein the security platform performs prompt analytics on the prompts entered by the user;
wherein the prompt analytics include prompt interaction analysis, prompt risk analysis, prompt injections detector and a prompt web application filter;
wherein the artificial intelligence system accepts prompts from a user;
wherein the security platform performs prompt analytics on the prompts entered by the user; and
wherein the prompt analytics include prompt interaction analysis, prompt risk analysis, prompt injections detector and a prompt web application filter.
